(19) United States
(12) Patent Application Publication
(10) Pub. No.: US 2017/0177012 A1
(43) Pub. Date: Jun. 22, 2017

(54) PRECISE PRESSURE CONTROL WITH OFF-ON VALVES AND FIXED VOLUME CHAMBERS

(71) Applicant: ADVANCED MATERIALS CORPORATION, Pittsburgh, PA (US)

(72) Inventors: Satoru Simizu, Pittsburgh, PA (US); Suryanarayan G. Sankar, Pittsburgh, PA (US)

(73) Assignee: ADVANCED MATERIALS CORPORATION, Pittsburgh, PA (US)

(21) Appl. No.: 15/129,809

(22) PCT Filed: Mar. 27, 2015
(86) PCT No.: PCT/US15/23121

§ 371 Date: Sep. 27, 2016

Related U.S. Application Data
(60) Provisional application No. 61/971,696, filed on Mar. 28, 2014.

(51) Int. Cl. G05D 16/20

(52) U.S. Cl. CPC G05D 16/2033

(57) ABSTRACT

A system and method is described to precisely control the pressure in a sample chamber over a wide range of pressures. The system comprises a sample chamber connected to additional chambers via on-off valves. The volumes of these chambers are accurately pre-measured. The valves can be electronically controlled by a controller, such as a computer with a processor. Computer control of these valves to vary the pressures in the chambers to achieve a precise target pressure in the sample chamber is performed in a sequence of steps where the pressure in each chamber is calculated after each step, thereby eliminating the requirement of measuring the actual pressure in the chambers.

### CROSS-REFERENCE TO RELATED APPLICATIONS

This application claims the benefit under 35 U.S.C. §119 of U.S. Provisional Application Ser. No. 61/971,696, filed on Mar. 28, 2014, which is incorporated by reference herein in its entirety.

### STATEMENT REGARDING FEDERALLY SPONSORED RESEARCH

Not applicable.

### BACKGROUND OF THE INVENTION

It is often desirable to set a gas pressure in a working chamber precisely to a given value. For example, an instrument to measure the amount of absorption and adsorption of gas by a solid sample typically sends a known amount of gas into a reaction chamber. Such a measurement is used to determine the thermodynamic properties of such reactions or surface characteristics, such as the effective surface area. For precise measurement, it is desirable that the amount of gas is well controlled. For a limited pressure range, this can be made using a flow control valve. However, it is difficult to use a flow control valve for a wide pressure range because do so requires changing the flow conductance for a wide range. Such a valve is difficult to design, manufacture, or maintain. It is also very expensive and often impractical. It would therefore be advantageous to develop a system and method of accurately setting gas pressure in a working chamber that is relatively inexpensive and consistent across a wide range of pressures.

### SUMMARY OF THE INVENTION

The present invention comprises a grouping of valves and chambers that can be controlled to precisely set a pressure in one of the chambers for a range of desired ending pressures. A method of setting the pressure relies on a series of steps, wherein one or more valves is opened and then closed during each step. When a valve is opened, the pressure is equalized between adjoining chambers separated by the opened valve. A controller determines the sequence and iterations of valve manipulations to reach the desired pressure.

### BRIEF DESCRIPTION OF THE DRAWINGS

Embodiments of the present invention will now be described, by way of example only, with reference to the accompanying drawings for the purpose of illustrating the embodiments, and not for purposes of limiting the invention, wherein:

FIG. 1 illustrates a simple pressure control system according to one embodiment of the present invention.

FIG. 2 illustrates a high precision pressure control system according to an alternative embodiment of the present invention.

FIG. 3 is a graph depicting the end pressures of a plurality of seven-, eight-, and nine-step valve manipulation sequences.

FIG. 4 is a graph showing the end pressures for a second nine-step sequence starting from the end of a first nine-step sequence.

FIG. 5 is a graph showing the end pressures of 4-way (single valve), 10-step manipulations and 7-way (single and dual valve), 7-step manipulations, according to embodiments of the present invention.

FIG. 6 is a flow chart of a pressure control method according to an embodiment of the present invention.

FIG. 7 is a flow chart of how generalized permutations of the valve manipulation may be systematically searched to find the optimal sequence.

### DETAILED DESCRIPTION OF THE INVENTION

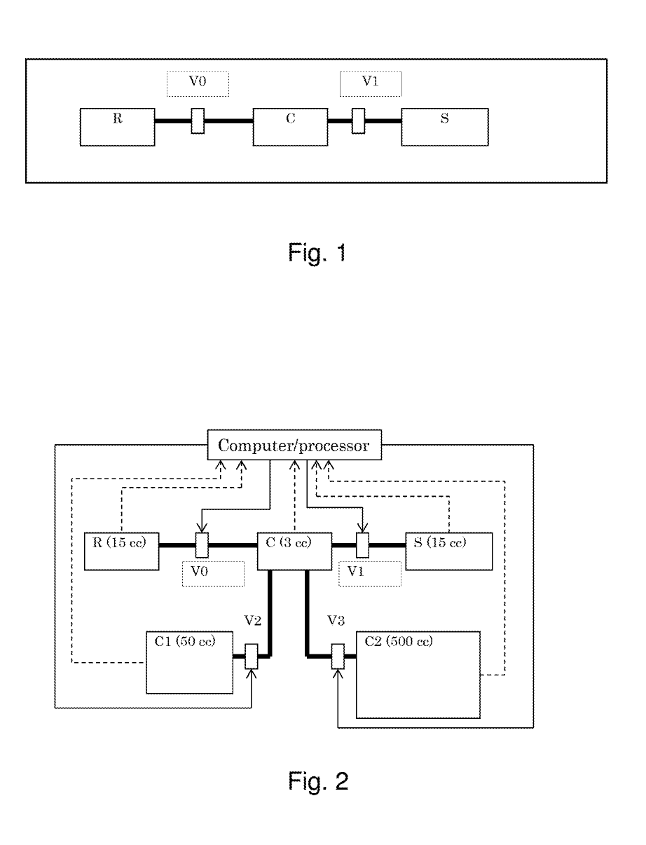

A pressure control system comprises multiple chambers with a known volume separated by on-off valves. For example, for a system shown in FIG. 1, the gas in a reservoir chamber (R) 101 can be sent to sample chamber (S) 102 in a stepwise manner through a connecting chamber (C) 103 until the pressure of sample chamber (S) 102 reaches close to a desired value. Similarly, the pressure in the sample chamber (S) 102 may be reduced by moving the gas in a stepwise manner via the connecting chamber (C) 103 toward an emptied reservoir chamber (R) 101. On-off valves 104 control the flow between the chambers. However, the control step is dependent on the initial pressure at reservoir chamber (R) 101 and sample chamber (S) 102 and the volumes of each chamber. When the pressure at reservoir chamber (R) 101 and sample chamber (S) 102 is dissimilar, the amount of transfer in a single step becomes large. Therefore, the pressure at reservoir chamber (R) 101 needs to be regulated, which is not easy to achieve for a wide pressure range.

Instead of attempting to control the pressure over a wide pressure range, the pressure in the sample chamber (S) 102 may be controlled precisely over a wide range of pressures by employing a grouping of valves 104 and chambers according to one embodiment of the present invention. In the preferred embodiment, one or more adjustment chambers 105 (C1 and C2), or additional control chambers, are connected to connecting, or control, chamber (C) 103 as shown schematically in FIG. 2. The volumes of these additional control, or adjustment chambers 105 (C1 and C2), are accurately pre-measured. These chambers 105 are connected to the reservoir chamber (R) 101 and sample chamber (S) 102 through the valves 104 V0, V1, V2 and V3 that can be electronically controlled by controller 106. While two adjustment chambers 105 are shown in FIG. 2, a plurality of adjustment chambers can be used.

The controller 106, which is a computer with a processor in the preferred embodiment, controls these valves 104 to vary the pressures in chambers R, C, C1 and C2 to achieve a precise target pressure in sample chamber (S) 102. The controller 106 determines the exact sequence of valve controls by analyzing a plurality of alternatives and choosing the sequence that results in the closest desired pressure. The manner in which the sequence is optimized is more fully described in following sections. Actual pressure measurements within each of the chambers R, S, C, C1, and C2 can optionally be acquired via pressure transducers housed within the chambers. Dashed lines in FIG. 2 represent a data connection between the pressure transducers or other pressure measuring means with the controller 106, which receives and processes the pressure signal. A pressure transducer may be required within reservoir R 101 to set the initial and refill pressures. However, the accuracy of the algorithms of the present invention has eliminated the need to measure actual pressures in chambers S, C, C1, and C2 during operation. Actual pressure measurements may be required for quality assurance checks to verify that the target pressure is met at system initial set up and at any appropriate interval. The system is only limited by inefficiencies and performance degradation of each component (e.g., valve, chamber, supply and feed lines, and physical connections therewith).

Computer-Controlled Valve Manipulation to Reach the Desired Pressure

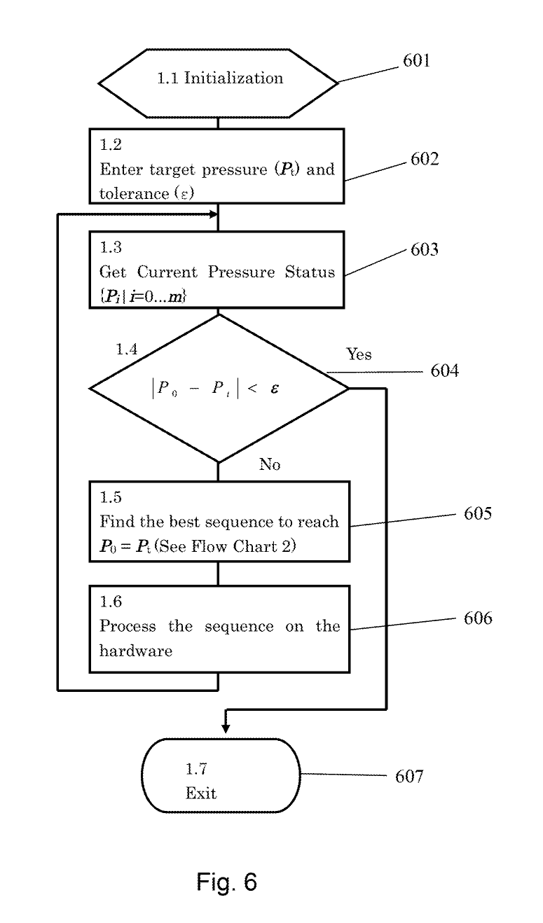

A computer-controlled system typically runs a procedure as shown in FIG. 6. The controller 106 (or processor), after proper initialization at step 601, takes the desired target pressure in the sample chamber 102 and acceptable tolerance as inputs at step 602. Suppose one wishes to bring the pressure (pS) in the sample chamber 102 to 1 atm (Pₜ=1 atm). One embodiment of the present invention includes a pressure transducer in sample chamber S 102 and checks the current pressure status of the chamber 102 at step 603. If the controller 106 finds pS already at the target pressure (after allowing for an acceptable tolerance), it exits from the control process at step 604. Otherwise, the controller 106 looks for a sequence of valve manipulations that will bring the pressure of the sample chamber 102 (pS) to the target value by a systematic search through selected permutations of valve manipulations at step 605. The method for such a search will be described in greater detail below.

In another embodiment of the present invention, actual pressure measurements are not required for chambers R, S, C, C1, or C2 since the initial pressure state of each chamber is known. For instance, if in the initial state, the pressure (pR) of the reservoir chamber 101 is known to be 80 atm and other chambers are evacuated to 0 atm, the following sequence of eight steps of valve manipulation will achieve pS (and pC) to be close to Pₜ (=1 atm). The physical operation of the sequence is accomplished at step 606. The sequence, with reference to the system shown in FIG. 2, is as follows:

Open (and close) V0: pR and pC become 66.67 atm.

Open (and close) V3: pC and pC2 become 0.398 atm.

Open (and close) V1: pC and pS become 0.066 atm.

Open (and close) V0: pR and pC become 55.567 atm.

Open (and close) V2: pC and pC1 become 3.145 atm.

Open (and close) V0: pR and pC become 46.83 atm.

Open (and close) V2: pC and pC1 become 5.618 atm.

Open (and close) V1: pC and pS become 0.992 atm.

The following table illustrates the pressure change in each chamber for the above valve manipulation sequence:

| | | | | Chamber | Chamber |
|---|---|---|---|---|---|
| Chamber | Reservoir | Control | Sample | 1 | 2 |
| Volume (cc) | 15 | 3 | 15 | 50 | 500 |
| | | PC | PS | | |
| ACTION | PR (atm) | (atm) | (atm) | PC1 (atm) | PC2 (atm) |
| Evacuate all | 0 | 0 | 0 | 0 | 0 |
| Chambers | | | | | |
| Fill reservoir to | 80 | 0 | 0 | 0 | 0 |
| 80 atm. | | | | | |
| Open &Close V0 | 66.67 | 66.67 | 0 | 0 | 0 |
| Open & Close V3 | 66.67 | 0.398 | 0 | 0 | 0.398 |
| Open & Close V1 | 66.67 | 0.066 | 0.066 | 0 | 0.398 |
| Open & Close V0 | 55.567 | 55.567 | 0.066 | 0 | 0.398 |
| Open & Close V2 | 55.567 | 3.145 | 0.066 | 3.145 | 0.398 |
| Open & Close V0 | 46.83 | 46.83 | 0.066 | 3.145 | 0.398 |
| Open & Close V2 | 46.83 | 5.618 | 0.066 | 5.618 | 0.398 |
| Open & Close V1 | 46.83 | 0.992 | 0.992 | 5.618 | 0.398 |

Search for the Best Sequence Among the Possible Permutations

A large number of permutations exist even for a limited number of valve manipulation steps. The following three permutations are possible for two step manipulation: (1) V0, V1; (2) V2, V1; and (3) V3, V1. The case where it ends with V1 is considered because the purpose of these manipulations is to set the sample chamber pressure (pS) that is changed when V1 opens. Also, permutations that manipulate the same valve consecutively are excluded because that does not change the pressure. The permutations increase quickly when the number of steps increase. For a three-step manipulation, the permutations are 9 and for four steps, they are 27. For an n-step manipulation of 4-single valves, the number of permutation is 3ⁿ⁻¹. A different pressure will result at the sample chamber 102 for each of these permutations; although, depending on the initial pressures, some of the permutations may give an identical result. It may be expected that some of the permutation may result in the desired pressure in the sample chamber 102. The resultant pressure for each valve manipulation (open and then close) can be calculated as follows based on a weighted average. When a valve that connects two chambers with a volume of V₁ and V₂ that holds a gas of pressure p₁ and p₂, respectively, the resultant pressure will be given by

p=(p₁V₁+p₂V₂)/(V₁+V₂)

This equation is exact for an ideal gas and is a good approximation for real gases.

The controller 106, or computer with a processor in the preferred embodiment, is then employed to calculate the resultant pressure for each step as illustrated above. In order to arrive at the above sequence as best, the computer calculates the final sample pressure for all 3280 possible sequences for maximum eight-step operation of the 4-valve system of FIG. 2. It then looks for the case where the final pressure is closest to the target pressure of 1 atm. In this example, the search for the possible permutations was limited to those that involve only a single valve manipulation or four ways (open V0, open V1, open V2, and open V3). However, as shown later, the search algorithm can be easily expanded to include all possible valve manipulations including simultaneous opening of any combination of valves such as open V0 and V1 or open V0, V2, and V3. Excluding consecutive selection of the same manipulation such as open V0 and again open V0, which is not meaningful, the number of possible sequences is given by (3ⁿ−1)/2 for maximum n-step valve manipulations for a 4-valve system.

Improving the Best Sequence Search—Longer Sequence

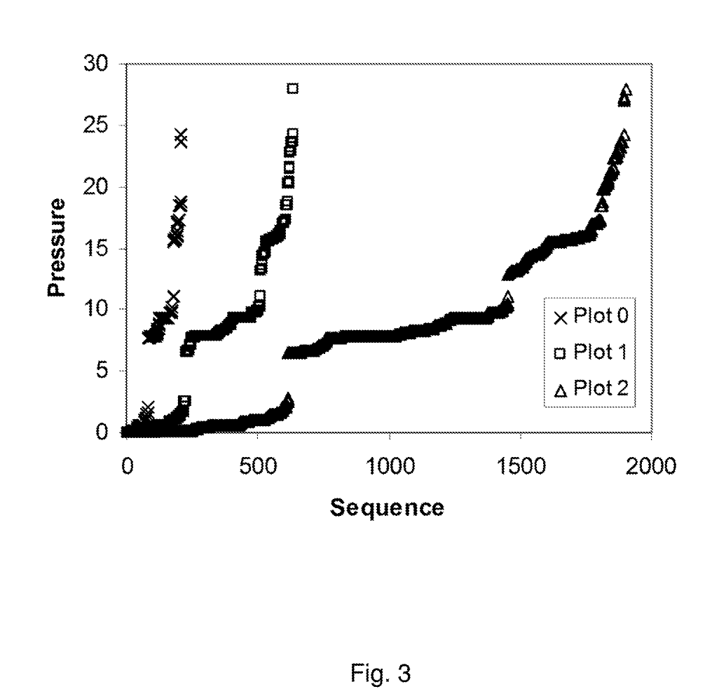

The possibilities for the final pressure are wider when the valve operation sequence is longer. For manipulations that involve four valves the number of possible sequences is 1093 for seven-step operation and increases to 3280 for eight-step and to 9841 for nine-step operation. FIG. 3 shows the possible end pressures when the sequence was started with a reservoir chamber 101 pressure of 80 atm and all other chambers empty. This initial condition was selected because it is easy to achieve in practice by setting the pressure to an available maximum pressure or emptying the chamber. Some of the sequences result in identical values. Such duplicates are removed in FIG. 3. It is clear from this illustration that the wide range of pressure is achievable almost continuously.

The nine-step valve manipulation covers a wide range of pressure as low as 0.004 atm to as high as 27.9 atm. However, there are several notable gaps indicating that a certain pressure cannot be realized. These gaps can be narrowed by increasing the sequence longer. However, when increasing the sequence the necessary search space increases rapidly.

Improving the Best Sequence Search—Branching

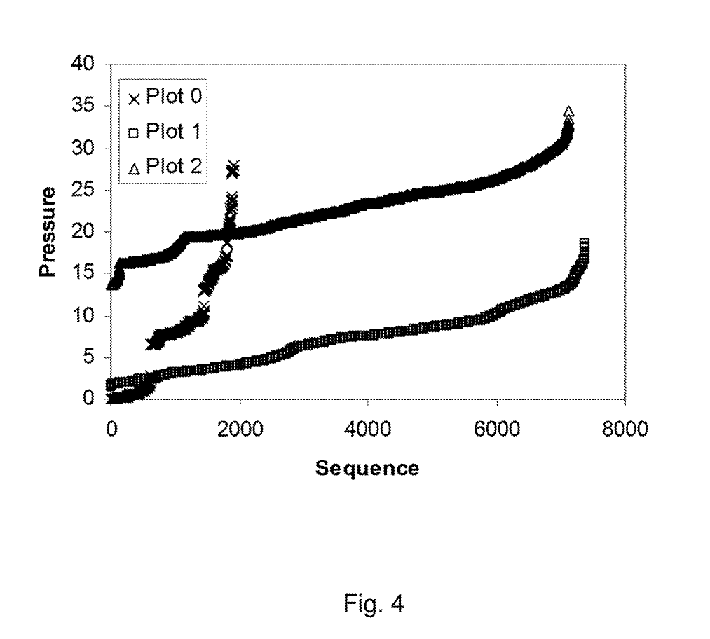

Instead of increasing the amount of steps, it is more effective to run a second nine-step sequence search beginning from one of the end result (2.864 atm) of the first nine-step sequence. FIG. 4 shows the results of such a branch search method. In two examples shown, the possible end pressure ranges from 2 atm to 18 atm or 14 to 34 atm almost continuously. While the depth of the search is 18 steps, the search is only for 19682 cases requiring only a fraction of a second with a personal computer with a processor that is employed for the instrument controller 106. In contrast, a full 18-step search will require testing for ˜2×10⁸ sequences. It becomes impractical even with a fast processor.

Application Example of Permutative Pressure Control

By combing the sequence search and branching method, one can precisely set pressure in the sample chamber (S) 102 in FIG. 2 to any desired value starting from either a fixed pressure or vacuum in reservoir chamber (R) 101.

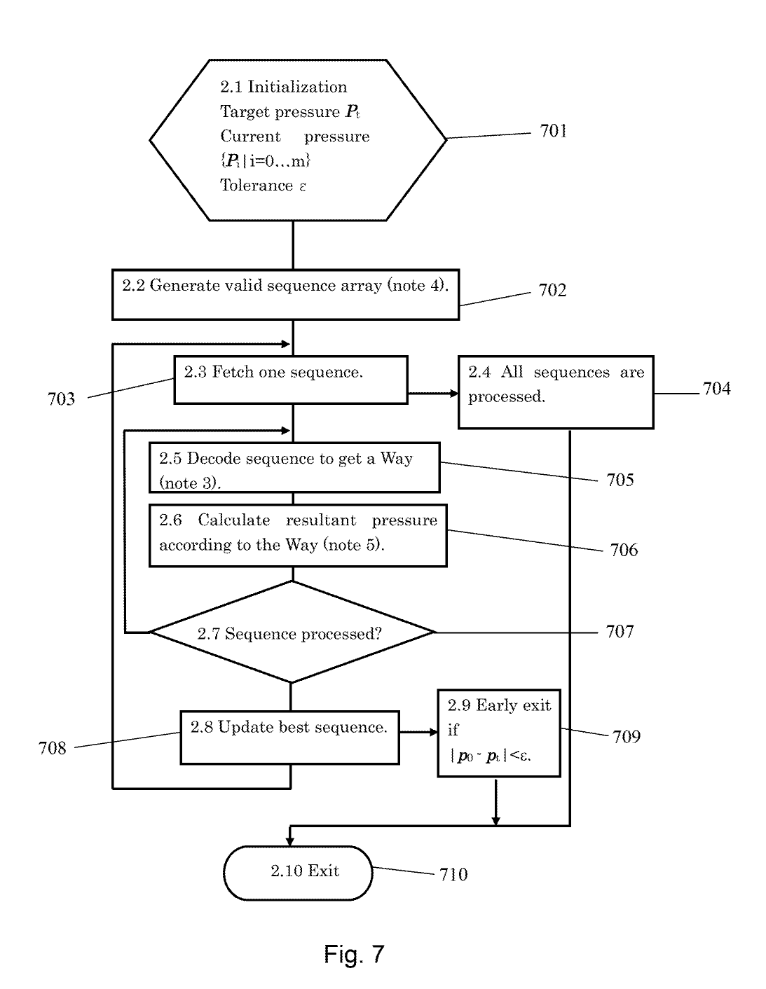

The following table shows the actual performance of the system of FIG. 2 when used for ramping up and then ramping down the pressure at sample chamber 102. In this example, a computer controlled system was running interactively with an operator. The operator first instructed the computer either to fill to a fixed pressure or to pump out chamber R 101. The operator then commanded the computer to run the search algorithm illustrated in the flow charts shown in FIGS. 6 and 7 by giving the target value. The search boundary (maximum number of manipulation steps) was also set by the operator. The controller 106 then found the best sequence and performed the on-off manipulation of the four valves. The resultant value at sample chamber S 102 was very close to the target value. The deviations are mostly within 0.02 atm, which is only 0.02% of the full scale of the employed pressure transducer and within the accuracy limit.

The following table shows test results with a system of four-valve, five-chamber configuration. The reservoir was either filled to a fixed pressure (32 atm) or pumped out as necessary.

| Reservoir | | Sample chamber pressure | | | |
|---|---|---|---|---|---|
| pressure (atm) | | (atm) | | | |
| Before | After | Target | Actual | Deviation | Comments |
| 32.07 | 25.12 | 1.00 | 0.98 | −0.02 | Fill |
| 25.12 | 15.85 | 2.00 | 1.97 | −0.03 | |
| 15.85 | 11.16 | 3.00 | 2.97 | −0.03 | |
| 11.16 | 6.97 | 3.50 | 3.50 | 0.00 | |
| 6.97 | 5.00 | 4.00 | 4.00 | 0.00 | |
| 31.76 | 25.84 | 5.00 | 4.98 | −0.02 | Refill |
| 25.84 | 18.20 | 7.00 | 6.98 | −0.02 | |
| 18.20 | 11.00 | 7.20 | 7.21 | 0.01 | |
| 11.00 | 9.76 | 9.00 | 8.99 | −0.01 | |
| 32.29 | 17.57 | 12.00 | 12.01 | 0.01 | Refill |
| 17.57 | 13.93 | 12.10 | 12.12 | 0.02 | |
| 13.93 | 12.36 | 12.20 | 12.20 | 0.00 | |
| 12.36 | 11.83 | 12.00 | 12.01 | 0.01 | |
| 0.01 | 2.07 | 11.00 | 10.97 | −0.03 | Pump out |
| 2.07 | 3.40 | 10.00 | 9.98 | −0.02 | |
| 3.40 | 4.64 | 8.00 | 7.98 | −0.02 | |
| 0.01 | 1.69 | 6.00 | 5.98 | −0.02 | Pump out |
| 1.69 | 2.22 | 5.90 | 5.90 | 0.00 | |
| 2.22 | 2.22 | 5.80 | 5.80 | 0.00 | |
| 2.22 | 2.67 | 5.00 | 4.99 | −0.01 | |
| 0.00 | 2.08 | 4.00 | 3.99 | −0.01 | Pump out |
| 0.00 | 0.85 | 3.00 | 2.98 | −0.02 | Pump out |
| 0.00 | 1.35 | 2.00 | 1.98 | −0.02 | Pump out |
| 0.00 | 0.36 | 1.50 | 1.48 | −0.02 | Pump out |
| 0.36 | 0.98 | 1.25 | 1.24 | −0.01 | |
| 0.00 | 0.66 | 1.00 | 0.98 | −0.02 | Pump out |
| 0.00 | 0.58 | 0.75 | 0.74 | −0.01 | Pump out |
| 0.00 | 0.52 | 0.50 | 0.49 | −0.01 | Pump out |

Generalized Valve Manipulation Sequence

The search algorithm of the present invention can be generalized to include simultaneous opening of two or more valves 104. When four valves are to be manipulated, there are 2⁴−1 ways to open the valve(s). In general, in manipulating m valves, there are k=2^{m}−1 ways to open them. In searching for the best sequence, one can look for the permutations of k ways to control the valve. One may include all k ways for the search or any subset of these ways. The calculation for the resultant pressure for each valve(s) opening step may be generalized as

$$p = ( {p}_{0} {V}_{0} + {\sum }_{i} {p}_{i} {V}_{i} {f}_{i} ) / ( {V}_{o} + {\sum }_{i} {V}_{i} {f}_{i} )$$

Here, the summation is over all the chambers of volume Vᵢ and pressure pᵢ that are connected to control chamber (C) 103 with a volume of V₀ and pressure of p₀ via connecting valve i. For the given pattern of opening, fᵢ is set to 1 if valve i is open and zero if valve i is closed. The number of permutations for k ways of operation for n steps will be given by ((k−1)ⁿ−1)/(k−2).

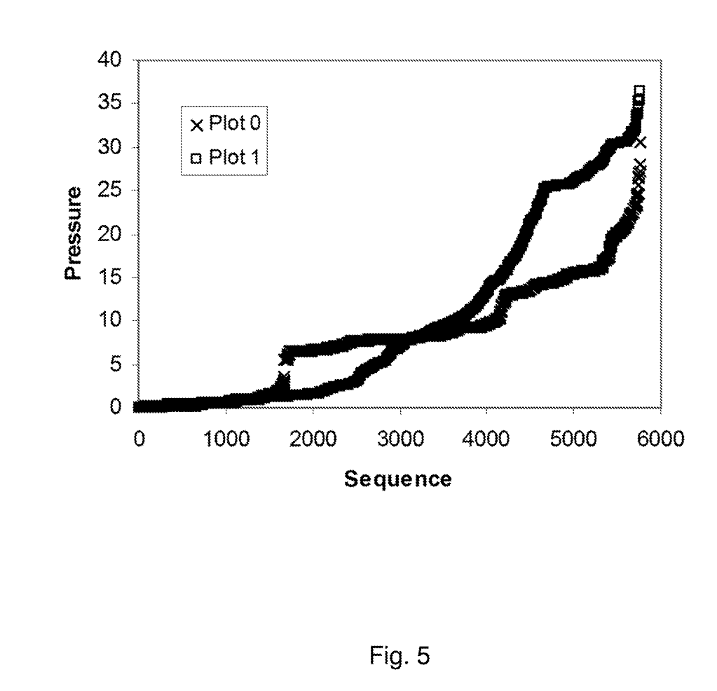

Inclusion of simultaneous valve manipulation is effective in reaching the desired pressure quickly. As shown in FIG. 5, which shows the end pressures for four-way (single valve) ten-step manipulations (line 501) and seven-way (single and dual valve), seven-step manipulations (line 502), notable gaps sometimes remain even after single valve manipulation of ten steps. When just three ways of simultaneous opening (V0 and V1, V0 and V2, and V0 and V3) are added to the basic 4-way single valve manipulation, those gaps are eliminated with just 7-steps operations. The attainable pressure range is also wider.

Generalized Best Sequence Search

The flow chart illustrated in FIG. 7 shows how these generalized permutations of the valve manipulation may be systematically searched to find the optimal sequence. The following definitions are useful in the discussion of the method shown in FIG. 7:

Chambers 1 . . . m are connected to Chamber 0 via Valves 0 . . . m−1.
Volume: V[i], i=0 . . . m
Pressure: p[i], i=0 . . . m
Valve Status: f[i], i=0 . . . m−1. 1(on) or 0(off)

After proper initialization of the relevant parameters at step 701, an array of valid sequences is generated for the selected ways of valve manipulation at step 702. A “way” is the valve opening pattern as defined by valve status. For example:

Way 0: f[0]=1, f[1]=0, f[2]=0, f[3]=0

Way 1: f[0]=0, f[1]=1, f[2]=0, f[3]=0

Up to 2^{m-1}−1 ways may be defined for m−1 valve system. Not all the ways need to be used to get a good result.

By way of further example, one may choose the following seven ways for valve manipulation: way 0: open V1, way 1: open V0, way 2: open V2, way 3: open V3, way 4: open V0 and V1, way 5: open V0 and V2, way 6: open V0 and V3. Any permutation of these 7 ways may be conveniently expressed by a single integer number using a base-7 representation. A sequence of way 1, way 3, way 5, way 0, for example, may be expressed by 0531₇. The decimal equivalent of this number is 267. The program creates an array of consecutive integers up to a certain maximum but excludes the ones that include repeats of the same ways. From the valid sequence array, 05331₇ will be excluded, for example, because repeating way 3 (open V3) does not give a new state. However, 03531₇ will be valid.

A valid sequence array is an array of sequences for the selected ways of valve manipulation. This is generated first up to the specified number of steps for all the possible permutations but excluding consecutive selection of the same way, which is meaningless. The number of valid sequences for k-way, n-step valve manipulation is ((k−1)ⁿ−1)/(k−2).

The program will then take one number in the array at step 703, extracts the way for valve manipulation from that number at step 705 and calculates the resultant pressure step-by-step (steps 706 and 707) using the weighted average formula. After completion of the calculation, it compares the final sample pressure with the target pressure. It saves the sequence if it is the best one at that point but discards it otherwise. It then repeats the process at step 708. In order to speed up the search process, an early exit test (step 709) may be included so that it ends the search early if a given tolerance is satisfied without processing all the given permutations. This not only saves in calculation time, but also could reduce actual processing time by conducting the search from a smaller number that corresponds to a shorter sequence of valve manipulation.

At step 705, the sequence is defined as an encoded integer number that, when decoded, indicates an ordered series of ways for valve manipulation. For k-way valve manipulation, the sequence is encoded as a base-k integer. For example:

4-way valve manipulation encoding

Sequence: Way 0, Way 1, Way 3, Way 0

Encoded integer: 0310₄ (decimal equivalent=52)

In this example, Way 0 should be reserved for the pattern for the final step.

To calculate the pressure in a chamber, the pressure of the chambers connected with opened valves will be calculated by the following equation:

$$p = ( {p}_{0} {V}_{0} + {\sum }_{i} {p}_{i} {V}_{i} {f}_{i} ) / ( {V}_{o} + {\sum }_{i} {V}_{i} {f}_{i} )$$

For a fully automated system, a supervisory module may be employed to monitor the initial state and perform filling and emptying of the chambers as necessary. Such a module may also select the length of the valve manipulation steps and the method of manipulation. For example, it may be all single valve manipulation or it might be a combination of single valve manipulation and simultaneous manipulation of multiple valves. It may also evaluate the result of the actual valve manipulation and instruct to repeat the process if the result is not satisfactory.

In order to perform the control described above, it is not imperative that the pressure at each chamber is actually known. In the example of FIG. 2, a pressure transducer can be installed at reservoir (R) 101 to set the initial and refill pressures. In an alternative embodiment of the present invention, a pressure transducer in reservoir (R) 101 may not be required if reservoir (R) 101 can be pressurized up to a set pressure by other external means with confidence. It is not necessary to install a pressure transducer or other pressure measuring means to each of control chambers C0, C1, and C2, and sample chamber (S) 102. The pressure at these chambers (as well as reservoir chamber (R) 101) is calculated by the weighted average formula by the above-described algorithm. Pressure transducers or other pressure measuring means are shown as optional (dashed lines in FIG. 2) and, as discussed above, can be utilized for initial and subsequent checks of the system's accuracy as required by the user. The system of the present invention can function as intended with pressure transducers in one, all, in combination, or none of the chambers (R, S, C, C1, C2). Below is a listing of some embodiments of the present invention with chambers having pressure transducers (if any):

A. only Sample Chamber S;

B. only Reservoir R;

C. only Sample Chamber S and Reservoir R;

D. only Control Chamber C;

E. only Sample Chamber S and Control Chamber C;

F. only Reservoir R and Control Chamber C;

G. only Sample Chamber S, Reservoir R, and Control Chamber C;

H. only Sample Chamber S and one or more adjustment chambers;

I. only Reservoir R and one or more adjustment chambers;

J. only Sample Chamber S, Reservoir R, and one or more adjustment chambers;

K. only Control Chamber C and one or more adjustment chambers;

L. only Sample Chamber S, Control Chamber C, and one or more adjustment chambers;

M. only Reservoir R, Control Chamber C, and one or more adjustment chambers;

N. Sample Chamber S, Reservoir R, and Control Chamber C and one or more adjustment chambers (but not all adjustment chambers);

O. Sample Chamber S, Reservoir R, and Control Chamber C and all adjustment chambers; and

P. none (no pressure measurements of chambers required).

The volumes of the vessels shown in FIG. 2 and the values of the starting pressure, 80 atm for example, are purely for illustrative purposes. The method is valid for other volumes and pressures of fluids.

The above method can also be applied to manipulating (1) precise volumes of gases in an industrial process such as manipulation and storage of natural gas, (2) precise volumes of gases such as mixing gaseous chemicals in a petro-chemical and/or pharmaceutical and drug industries and (3) precise volume controls for mixing different paints and resins. The present invention is not to be limited to gas. It is suitable for any fluid environment including liquid and gas-liquid phase states.

While the disclosure has been described in detail and with reference to specific embodiments thereof, it will be apparent to one skilled in the art that various changes and modifications can be made therein without departing from the spirit and scope of the embodiments presented. Thus, it is intended that the present disclosure cover the modifications and variations of this disclosure provided they come within the scope of the appended claims and their equivalents.

What is claimed is:

1. A pressure control system for setting a pressure in a sample chamber, the system comprising:
a reservoir chamber;
a connecting chamber in fluid communication with the reservoir chamber, wherein a first valve separates the connecting chamber and the reservoir chamber;
a sample chamber in fluid communication with the connecting chamber, wherein a second valve separates the sample chamber and the connecting chamber; and
a controller, wherein the controller is capable of causing the first valve and the second valve into one of an open or closed position.

2. The pressure control system of claim 1, further comprising:
a plurality of control chambers in fluid communication with the connecting chamber, wherein a control valve connected to the controller separates each control chamber from the connecting chamber.

3. The pressure control system of claim 2, wherein the plurality of control chambers comprises:
a first control chamber having a first control volume;
a second control chamber having a second control volume,
wherein the first control volume is unequal to the second control volume.

4. The pressure control system of claim 1, wherein each of the reservoir chamber and the sample chamber include a pressure transducer for determining the respective pressure of the reservoir chamber and the sample chamber.

5. The pressure control system of claim 4, wherein the reservoir chamber pressure transducer measures the pressure of a chamber connected to the reservoir chamber by an open valve.

6. The pressure control system of claim 4, wherein the sample chamber pressure transducer measures the pressure of a chamber connected to the sample chamber by an open valve.

7. The pressure control system of claim 2, wherein the controller comprises:
a computer that receives data about an initial pressure of at least one of the sample chamber, the connecting chamber, the reservoir chamber, and the plurality of control chambers,
wherein the computer identifies a series of valve manipulations that will result in a final sample chamber pressure that substantially equals a desired sample chamber pressure
wherein the computer causes the first valve, the second valve, and the control valve for each control chamber to open or close in accordance with the identified series of valve manipulations.

8. The pressure control system of claim 7, wherein the computer identifies the series of valve manipulations based on a weighted average method.

9. The pressure control system of claim 8, wherein the series of valve manipulations comprises a sequence of at least seven steps.

10. The pressure control system of claim 9, wherein the computer identifies a second series of valve manipulations beginning with an ending sample chamber pressure, when the first series of valve manipulations does not produce the desired sample chamber pressure.

11. A method of setting a pressure in a sample chamber that is fluidly connected to an arrangement comprising a connecting chamber, a reservoir chamber, and a plurality of control chambers, wherein a valve separates each chamber in the arrangement, the method comprising:
identifying a desired sample chamber pressure;
calculating a current sample chamber pressure;
determining a preferred sequence of valve manipulations required to reach the desired sample chamber pressure; and
manipulating the valves in accordance with the preferred sequence.

12. The method of claim 11, wherein determining a sequence of valve manipulations to reach the desired chamber pressure comprises the steps of:
(a) generating a valid sequence array comprised of a plurality of sequences;
(b) fetching a sequence from the sequence array;
(c) calculating the ending sample chamber pressure according to the sequence;
(d) comparing the calculated ending sample chamber pressure to the desired sample chamber pressure, wherein the sequence is identified as the preferred sequence if the ending sample chamber pressure is substantially the desired sample chamber pressure;
(e) repeating steps (b) through (d) until the preferred sequence is identified.

13. The method of claim 11, further comprising:
setting the desired sample chamber pressure to successively higher pressures on a defined time interval to determine pressure-composition isotherms when testing the absorption of a material.

14. The method of claim 11, further comprising:
setting the desired sample chamber pressure to successively lower pressures on a defined time interval to determine pressure-composition isotherms when testing the desorption of a material.

15. The method of claim 11, further comprising:
calculating the temperature of a material based on the desired sample chamber pressure.

16. The method of claim 11, further comprising:
identifying an initial concentration of a sample in the sample chamber;
calculating a final concentration of the sample created from mixing the sample with additional material as a result of the sequence.

17. The method of claim 11, wherein the method is adapted to be used in at least one of the following industries: natural gas, petro-chemical, pharmaceutical, paint, and resins.
